(19) United States
(12) Patent Application Publication
(10) Pub. No.: US 2010/0280743 A1
(43) Pub. Date: Nov. 4, 2010

(54) INDIVIDUAL ACCUMULATOR, HIGH-PRESSURE COMPONENT, AND COMMON RAIL FUEL INJECTION SYSTEM, AS WELL AS AN INTERNAL COMBUSTION ENGINE, ELECTRONIC CONTROL UNIT, AND METHOD FOR THE OPEN-LOOP AND/OR CLOSED-LOOP CONTROL OF AN INTERNAL COMBUSTION ENGINE

(75) Inventors: Marc HEHLE, KONSTANZ (DE); Robby GERBETH, FRIEDRICHSHAFEN (DE); Joerg REMELE, HAGNAU (DE); Guenther SCHMIDT, FRIEDRICHSHAFEN (DE); Ralf SPEETZEN, FRIEDRICHSHAFEN (DE); Michael WALDER, RAVENSBURG (DE); Michael Willmann, Bermatingen (DE)

Correspondence Address: LUCAS & MERCANTI, LLP, 475 PARK AVENUE SOUTH, 15TH FLOOR, NEW YORK, NY, 10016, US

(73) Assignee: MTU FRIEDRICHHAFEN GMBH, Friedrichshafen (DE)

(21) Appl. No.: 12/772,713

(22) Filed: May 3, 2010

(30) Foreign Application Priority Data
May 4, 2009 (DE) 10 2009 002 793.9

(51) Int. Cl. F02D 41/30; F02M 63/00; F02M 69/46

(52) U.S. Cl. 701/103; 123/447; 123/456

(57) ABSTRACT

An individual accumulator for a high-pressure component of a high-pressure fuel guide of a common rail fuel injection system. The individual accumulator is equipped with a pressure sensor, and the common rail fuel injection system is equipped with a source of high pressure and a fuel injector, which has a fluid connection with this source of high pressure via the high-pressure fuel guide, for injecting the fuel into a working chamber of an internal combustion engine. The pressure sensor is designed as a strain sensor.

### BACKGROUND OF THE INVENTION

The invention concerns an individual accumulator for a high-pressure component of a high-pressure fuel guide of a common rail fuel injection system, wherein the individual accumulator is equipped with a pressure sensor, and the common rail fuel injection system is equipped with a source of high pressure and a fuel injector, which has, a fluid connection with this source of high pressure via the high-pressure fuel guide, for injecting the fuel into a working chamber of an internal combustion engine. The invention also concerns a high-pressure component of a high-pressure fuel guide of a common rail fuel injection system with an individual accumulator of this type. Furthermore, the invention concerns a common rail fuel injection system with a source of high-pressure and a fuel injector, which has a fluid connection with this source of high pressure via a high-pressure guide, for injecting the fuel into a working chamber of an internal combustion engine, wherein the high-pressure guide has a high-pressure component as described above and/or individual accumulator with a pressure sensor. In addition, the invention concerns an internal combustion engine with a common rail fuel injection system and an electronic control unit for the open-loop or closed-loop control of an internal combustion engine. The invention further concerns a method for the open-loop and/or closed-loop control of an internal combustion engine with a common rail fuel injection system of the aforementioned type by means of an electronic control unit, in which, during a measurement interval, a pressure of the individual accumulator is detected and stored, and a significant change in the pressure is interpreted as the start of injection or the end of injection for the control system.

In an internal combustion engine, the start of injection and the end of injection determine to a great extent the quality of the combustion and the composition of the exhaust gas. To maintain the legally required limits, these two parameters are usually automatically controlled by an electronic control unit. In an internal combustion engine with a common rail fuel injection system, the practical problem arises that there is a time lag between the start of energization of the injector, the needle lift of the injector, and the actual beginning of injection. There is a corresponding problem with the end of injection. Inaccuracy in the automatic control of the start of injection and the end of injection ultimately leads to inaccuracy in the amount of fuel supplied to the internal combustion engine.

To eliminate these problems. DE 3 118 425 C2 proposes a device for determining the quantity of fuel supplied to the combustion chambers of a diesel engine by means of a pressure sensor, wherein the start and end of the injection process of a pump element are deduced from threshold values of the gradient of the pressure measured by the sensor. To this end, it is proposed that the pressure sensor be installed in the fuel line or as close as possible to the injection nozzle or at the pump element. For this purpose, it is explained that the pressure sensor should be placed as close as possible to the injection nozzle to achieve measurement results that are as exact as possible with respect to time, although it is also acknowledged that this installation site can also lead to corruption of measurements in the pressure sensor signal due to pressure fluctuations in the fuel line. According to DE 3 118 425 C2, the best measurement result for the quantity of injected fuel is obtained if the pressure variation is retrieved at the pump element, since at this measuring site the fuel delivery, and not so much the fuel metering at the injection valve, is then detected. However, a problem here is that a disturbance variable characterized, for example, by the delivery frequency of a high-pressure pump and/or the injection frequency of an injector is superimposed on a measured pressure variation. According to DE 3 118 425 C2, a characteristic for controlling the injection can be obtained from the measured pressure variation only by filtering or gradient formation, but this causes a definite time lag relative to the measured raw signal and can lead to improper corruptions of the characteristic.

DE 10 2005 053 683 A 1 describes a fuel injection system with a high-pressure fuel source and at least one injector for injecting fuel into a combustion chamber of an internal combustion engine, wherein the high-pressure fuel source and an injection opening of the injector are connected with each other by a fuel-conveying high-pressure channel. To avoid errors with respect to the determination of an actual start of injection and an actual end of injection, the reference proposes that a strain sensor be arranged on a body in which the high-pressure channel is formed and thus that the elastic change in shape of the body that is caused by the pressure in the high-pressure channel be determined. For this purpose, the strain sensor can be mounted on the high-pressure line, advantageously, as close as possible to the injector. However, it is also possible for the strain sensor to be mounted on the injector itself and here preferably on the nozzle, which is part of the injector. Of course, in the case of the injector—as described in DE 10 2005 053 683 A1—the ratio of the inside diameter of the tube and the wall thickness is very much less favorable than in the case of the high-pressure line, so that the signal of the strain sensor to be expected at the injector is small, and the evaluation is correspondingly difficult. In addition, the mounting of a strain sensor according to DE 10 2005 053 683 A1 on the injector itself is difficult for design reasons due to the limited installation space. Moreover, with the solution disclosed in the cited application, the disturbance variable problem can likewise be avoided only with filtering of the measuring signal and this once again with definite time lag of the measuring signal relative to the raw signal.

In addition, the aforementioned solutions were described exclusively for fuel injection systems without individual accumulators. On the other hand, it was recognized by the applicant that, in a common rail fuel injection system with individual accumulators, the pressure can be determined directly in the individual accumulator by means of a pressure sensor described in DE 10 2006 034 515 B3. For this purpose, the pressure sensor can be arranged, for example, in the plug of the individual accumulator. To this end, the pressure sensor has a first chamber, which is connected via a throttle shutter with the inner chamber of the individual accumulator, and a measuring cell for detecting a first pressure level in the first chamber and for detecting the individual accumulator pressure level in the inner chamber of the individual accumulator.

DE 10 2006 034 515 B3 provides an approach to solving the problems of the type outlined above, which is basically superior to other ideas but is capable of improvement.

An advantageous method for evaluating individual accumulator pressure was proposed, for example, by the applicant in DE 10 344 181 A1. In this connection, a method of the type mentioned at the beginning is used to compute a virtual start of injection as a function of the end of injection by means of a mathematical function.

It would be desirable to have a solution that largely avoids the influence of disturbance variables in pressure measurements by pressure determination at an individual accumulator in a common rail fuel injection system which allows a measurement of the individual accumulator pressure that is simple yet exact.

### SUMMARY OF THE INVENTION

The present invention provides a device and a method of the aforementioned type, with which an individual accumulator pressure measurement can be realized that largely avoids disturbance variables in the simplest possible way and which provides improved accuracy.

The goal with respect to the device is achieved by means of an individual accumulator of the aforementioned type, in connection with which it is provided, in accordance with the invention, that the pressure sensor is designed as a strain sensor.

The invention includes a high-pressure component of a high-pressure fuel guide of a common rail fuel injection system with an individual accumulator of this type. In accordance with the invention, the high-pressure component is designed for connection to a high-pressure line outside the injector or for integration in a high-pressure line outside the injector, or the high-pressure component is designed in the form of an injector.

The invention specifies a common rail fuel injection system of the aforementioned type, in which, in accordance with the invention, the pressure sensor is designed as a strain sensor.

The invention further specifies an internal combustion engine with a common rail fuel injection system and with an electronic control unit for the open-loop or closed-loop control of the internal combustion engine. In accordance with the invention, the control unit is designed for processing a measured quantity of a strain sensor for the pressure of the individual accumulator, and especially has a signal input which is connected with a signal output of the strain sensor.

The invention also specifies an electronic control unit for the open-loop or closed-loop control of an internal combustion engine, which, in accordance with the invention, is designed for processing a measured quantity of a strain sensor for the pressure of the individual accumulator. In particular, the electronic control unit has a signal input, which is designed for signal connection with a signal output of the strain sensor.

The invention proceeds from the consideration that prior-art systems without an individual accumulator always have to additionally deal with the fundamental problem of the influences of disturbance variables or, when these are corrected, with a time lag in the connected characteristic. In addition, in systems of this type, a comparatively inexact measurement at a high-pressure line is to be preferred to a measurement at the injector clue to the difficult measurement situation and the difficult situation with respect to installation space, as was explained earlier. In this respect, the invention recognized that a pressure measurement directly on the individual accumulator is advantageously suitable not only for making available a pressure measurement that is as exact as possible but also for avoiding the problem of the effect of disturbance variables that is well known in the prior art. In addition, the invention recognized that when a strain sensor is used tier the pressure measurement directly on the individual accumulator, the problems that are otherwise usually encountered in connection with a pressure measurement directly at the injector are avoided, and a pressure measurement can be realized comparatively simply. The invention has thus realized in a surprisingly convincing way that the expected signal of a strain sensor directly on the individual accumulator by all means falls in a favorable range clue to the greater volume available at the individual accumulator.

As was recognized by the invention, the idea of an individual accumulator pressure measurement with a strain sensor leads to an individual accumulator pressure measurement signal which is directly proportional to the actual pressure surge in the individual accumulator and from which the parameters of the injection—injection start, injection duration, and injection end—can be directly determined, i.e., in particular, without further filtering or gradient formation.

Accordingly, the idea of the invention also leads to a method of the aforementioned type, in which an electronic control unit is used to determine and store a pressure of the individual accumulator during a measurement interval, and a significant change in the pressure is interpreted as an injection start or injection end for the open-loop control. Following the idea of the invention, it is provided, in accordance with the invention, that the pressure of the individual accumulator is measured by a pressure sensor in the form of a strain sensor on the individual accumulator. Moreover, the method can be carried out and evaluated basically as described in DE 10 344 181 A1. Reference is made to the disclosure of DE 10 344 181 A1 for detailed information on how the method is carried out, and the contents of DE 10 344 181 A1 are herewith incorporated by reference in the present application.

All together, the idea of the invention has the further advantageous result that an individual accumulator pressure signal recorded with a strain sensor can be uniquely assigned to the given injector and the given cylinder, since no interfering frequencies of other cylinders are present in the pressure signal of the individual accumulator or, if they are, they are present only to a negligible extent. This has the effect, among others, that filtration and/or calibration of the measuring signal becomes largely superfluous in accordance with the idea of the invention, since the measuring signal is independent of the number of cylinders and the firing order in the internal combustion engine. In an especially advantageous way compared to previously known methods of measurement, the idea of the invention has utilized the fact that a pressure surge in the individual accumulator is usually higher by a factor of up to five than in a pressure measurement outside an individual accumulator, i.e., the signal-to-noise ratio and thus the accuracy of measurement are considerably greater with the present invention than with the prior art. Moreover, the restriction of installation space that was a problem in connection with the prior art is greatly improved by the present invention, since more space is available in the individual accumulator than, for example, at the tip of an injector or the like.

With respect to the method in accordance with the present invention, the method described in detail in DE 10 344 181 A1 is only one of various possibilities for implementing the idea described here. Depending on requirements, procedures for determining pressure can be selected according to their suitability for a specific application, where, as proposed in accordance with the idea of the invention, a pressure determination by a strain sensor on the individual accumulator is to be used.

In accordance with an especially preferred refinement of the high-pressure component, a hydraulic resistance is integrated in the high-pressure guide immediately upstream of the individual accumulator. A hydraulic decoupling of the individual accumulator relative to the remainder of the system can be improved by a hydraulic resistance placed upstream of the individual accumulator and in the upstream fuel flow direction. Additionally or alternatively, it is also possible, if necessary, to use a hydraulic resistance placed downstream of the individual accumulator in the downstream fuel flow direction. Accordingly, it is also possible for a hydraulic, resistance to be located upstream of the individual accumulator and for another hydraulic resistance to be located downstream of the individual accumulator. In other words, depending on requirements, the individual accumulator can be realized in combination with an upstream and/or downstream hydraulic throttle as part of a high-pressure component. When the high-pressure component in accordance with the present invention has been refined in this way, not only can it be coordinated in an optimized way with the remainder of the high-pressure guide, but also feedback of hydraulic disturbance variables to the individual accumulator, such as interfering pressure frequencies known from the prior art, can be suppressed or eliminated.

It is also advantageous for the strain sensor to be designed as a strain gage. The reader is referred, for example, to DE 10 2005 053 653 A1 for a detailed description of the exact mode of operation and action of a strain gage. A strain gage can be realized in a comparatively simple way and can be mounted on the individual accumulator in a space-saving way. Disadvantages known from the prior art with respect to a pressure measurement by a strain sensor, especially a strain gage, on an injector are advantageously avoided when a strain sensor is used on an individual accumulator in accordance with the idea of the invention.

Additional refinements of the idea of the invention relate to the design and arrangement of the individual accumulator. It is advantageous to mount the strain sensor on the outside of a wall of the individual accumulator. To this end, the wall can be provided with a suitable wall thickness relative to a measure of the volume of the individual accumulator in order to increase the measurement accuracy of the strain sensor.

It is advantageous for a high-pressure connection of the high-pressure guide to open directly into the individual accumulator. This has advantages not only with respect to the fuel conveyance but also with respect to the measurement accuracy of the pressure measurement on the individual accumulator.

It is also advantageous for the individual accumulator itself to be shaped in such a way that a diameter of the individual accumulator determined transversely to an axial direction of conveyance of the fuel is designed greater than a transverse diameter of the high-pressure component upstream of the individual accumulator determined transversely to an axial direction of conveyance of the fuel. In particular, an individual accumulator is characterized by the fact that it has a greater transverse diameter than the remaining high-pressure fuel guide.

To form a hydraulic resistance upstream and/or downstream of the individual accumulator, it is advantageous that the course of the diameter of the high-pressure component along an axial direction of conveyance of the fuel be necked down upstream and/or downstream of the individual accumulator to form a throat. This provides an especially simple means of realizing a hydraulic throttle, which, if necessary, can be supplemented by additional elements and/or design of the fuel vide.

To refine a common rail fuel injection system, it is especially provided for this purpose that the high-pressure guide has a hydraulic resistance upstream of the individual accumulator that is greater than a hydraulic resistance of the high-pressure guide after the outlet of the high-pressure source. Although the prior art usually provides for keeping the hydraulic resistance of the individual accumulator and the supply line from the high-pressure source as low as possible in order to achieve immediate and unhindered injection, this can also be achieved in accordance with the present refinement and, in addition, without feedback of disturbance variables to the volume in the individual accumulator.

Another advantageous provision is a common rail fuel injection system in which, in the high-pressure guide, only the individual accumulator is provided with a pressure sensor, especially in the form of a strain gage. It was found that the mounting of a strain sensor only on the individual accumulator can be sufficient to proportion a suitable fuel supply into the working chamber of an internal combustion engine. In addition, it may be advantageous in some cases to provide the high-pressure source, i.e., especially the rail or the high-pressure accumulator, with a pressure sensor, especially with another strain sensor, advantageously in the form of another strain gage. It is advantageous for a high-pressure pump to be installed upstream of the high-pressure accumulator. In accordance with this refinement, a pressure measurement at the high-pressure source along with a pressure measurement at the individual accumulator has proven especially suitable for the complete, simple, trouble-free and exact characterization of the fuel injection for the purpose of controlling the fuel injection for an internal combustion engine.

Similarly, in accordance with a refinement related to the method of the invention, the pressure measured at the individual accumulator can be made available to the control unit in addition to or alternatively to a pressure measured at the high-pressure source. In the case that the pressure of the high-pressure source is measured in addition to the pressure at the individual accumulator, it was found to be advantageous to use the pressure measured at the individual accumulator, in accordance with the method, for the plausibility testing for the pressure measured at the high-pressure source. In particular, a process step is provided for this purpose, in which a plausibility test for correctness of the pressure measured at the high-pressure source is carried out by comparing a pressure measured at the individual accumulator and a pressure measured at the high-pressure source. This makes it possible to eliminate the effects of disturbance variables on a pressure signal measured at the high-pressure source. For the case that a pressure measurement at the high-pressure source should be invalid clue to an error or other disturbance, it is possible, in accordance with an advantageous refinement of the method, to make the measurement of the pressure at the individual accumulator available to the control unit instead of the measurement of the pressure at the high-pressure source. In accordance with a refinement of the method, it is basically possible for an individual accumulator pressure measurement taken, in accordance with the idea of the invention, by means of a pressure sensor, preferably in the form of a strain sensor, in a variety of ways for the open-loop and/or closed-loop control of the internal combustion engine. In particular, the method provides that the individual accumulator pressure measurement is used for the open-loop and/or closed-loop control of the course of a main injection. Additionally or alternatively, an individual accumulator pressure measurement can also be used for controlling the course of a preinjection and/or post-injection.

In accordance with a refinement of the method, the control unit can be initiated and its initial settings set by supplying a measured quantity for the pressure of the individual accumulator as a signal output at the strain sensor. A first measured pressure value is determined before the internal combustion engine is started. A second measured pressure value is determined in a static state of the internal combustion, engine, and a third measured pressure value is related to the first and/or second measured pressure value.

In this connection, the first measured pressure value can be used for reading in a voltage level of the strain sensor, especially a strain gage, i.e., in practical terms, for determining a zero-voltage signal state. The second measured pressure value can be assigned as a practical matter to a measured pressure value that is a determining value for the pressure in the high-pressure source, since in the static state an individual accumulator pressure should basically correspond to the pressure in the high-pressure source. Any further, third measured pressure value—for example, a pressure surge at the individual accumulator when the injector is opened—can be related to the first and/or second measured pressure value. In this way, the pressure variation at the individual accumulator can be directly determined comparatively exactly and simply and made available to the control unit.

In addition, as input variables for the open-loop and/or closed-loop control of the internal combustion engine, the method can advantageously utilize an individual accumulator pressure and possibly a pressure of the high-pressure source and especially additional input variables. For example, additional input variables can comprise a speed signal for the internal combustion engine, additional individual accumulator pressure signals for other individual accumulators of the other cylinders, and possibly other input signals from the periphery of the internal combustion engine, for example, signals for the charge air pressure of a turbocharger and the temperatures of the coolant and/or lubricant and the fuel.

In addition, the method can advantageously utilize various kinds of output variables for the open-loop and/or closed-loop control of an internal combustion engine. These include especially an output variable for driving a suction throttle upstream of the high-pressure pump and a signal for driving the number of injectors and here especially the start of injection and the end of injection. Other output variables can be related to the periphery of the internal combustion engine, such as control signals for the open-loop and/or closed-loop control, for example, of an exhaust gas recirculation valve.

Specific embodiments of the invention will now be described with reference to the drawings. The drawings are not necessarily intended to be true to scale but rather are presented in schematic form and/or slightly distorted where this serves to improve clarity of explanation. In regard to supplementation of the disclosure immediately apparent from the drawings, the reader is referred to the pertinent prior art. In this connection, it should be considered that many different modifications and changes can be made with respect to the form and detail of an embodiment without departing from the general idea of the invention. The features of the invention disclosed in the specification, in the drawings, and in the claims can be essential to refinement of the invention both individually and in any desired combination. In addition, all combinations of two or more features disclosed in the specification, the drawings and/or the claims are part of the invention. The general idea of the invention is not limited to the exact form or detail of the preferred embodiment shown and described below or limited to an object that would be restricted in comparison to the object claimed in the claims. With respect to the specified dimensional ranges, values that lie within the specified limits are also meant to be disclosed as limits and can be optionally used and claimed. Further advantages, features, and details of the invention are apparent from the following description of the preferred embodiments and from the drawings.

### BRIEF DESCRIPTION OF THE DRAWINGS

FIG. 1 is a schematic drawing of an internal combustion engine with a common rail fuel injection system and a high-pressure component with an individual accumulator in accordance with an embodiment of the invention.

FIG. 2 shows an embodiment of an individual accumulator, which can be used, for example, in the embodiment of FIG. 1 as part of an integration in the injector.

FIG. 3 is a schematic representation of a high-pressure component in the form of an individual accumulator with a pressure sensor in the form of a strain sensor in accordance with one embodiment of the invention.

### DETAILED DESCRIPTION OF THE INVENTION

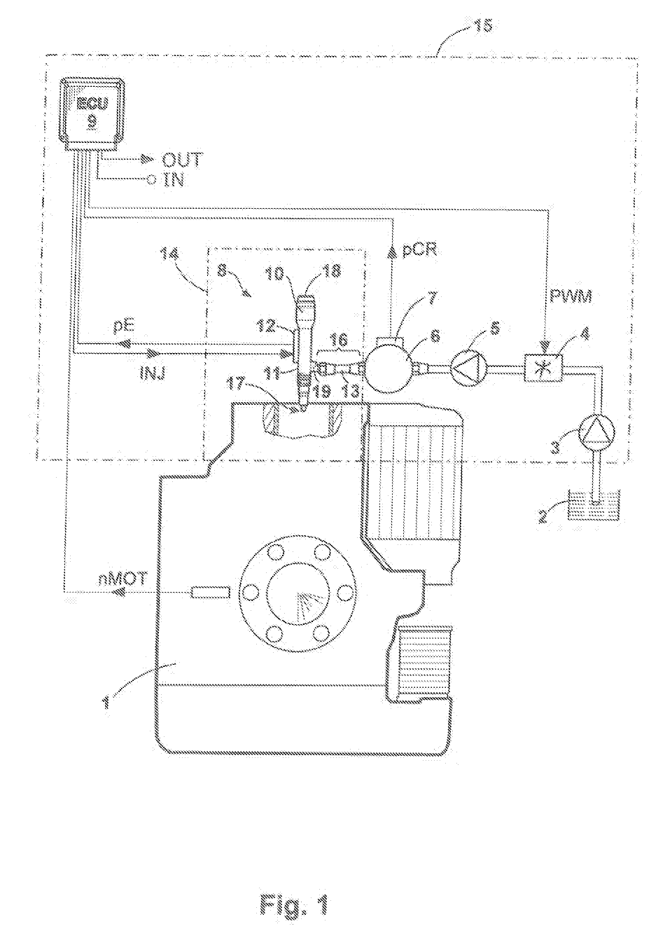

FIG. 1 shows an internal combustion engine 1 with a common rail fuel injection system 15, which is designed for injecting fuel drawn from a fuel tank 2 by a low-pressure pump 3 into a working chamber of the internal combustion engine 1. The common rail fuel injection system 15—hereinafter referred to as the common rail system 15—is provided in the present case with an electronic device 9—hereinafter referred to as the electronic control unit 9—for the open-loop and/or closed loop control of the internal combustion engine 1. Likewise in accordance with the idea of the invention, the common rail system 15 also has a high-pressure component 14 with an individual accumulator 10, which is designed for the temporary storage of the fuel before injection by the injector 8.

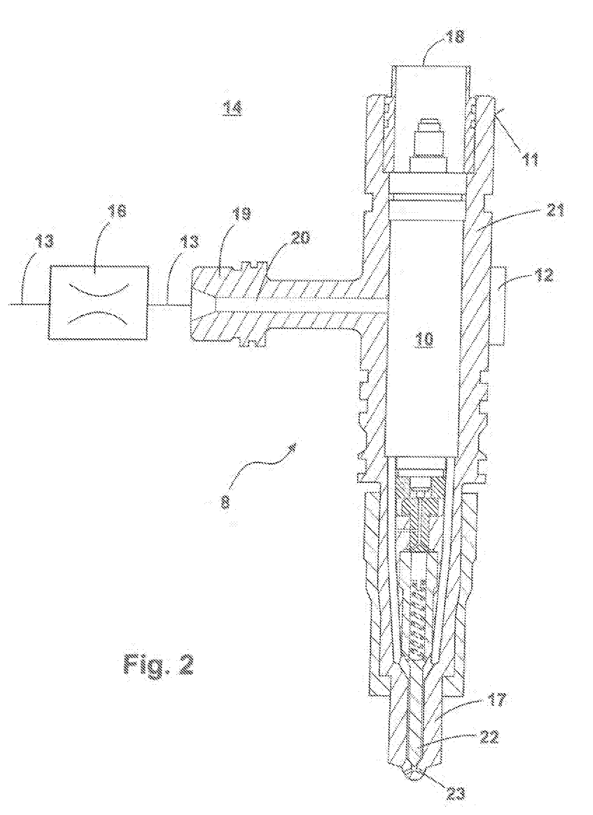

In detail, the common rail system 15 comprises the following mechanical components: the low-pressure pump 3 for pumping fuel from the tank 2, a suction throttle 4 for controlling the volume flow of the fuel, a high-pressure pump 5 for delivering the fuel, while at the same time increasing the pressure, into a high-pressure source 6 that is under high pressure—hereinafter referred to as rail 6. In addition, a number of injectors that matches the number of cylinders is provided for injecting the fuel into a working chamber, in the present case a combustion chamber, of the internal combustion engine 1. Of these injectors, one injector 8 is shown symbolically for the number of injectors as part of a high-pressure component 14 shown symbolically for the number of high-pressure components. In the present case, the individual accumulator is integrated in the injector 8. This can basically be clone in a variety of ways and will be explained in detail later in connection with FIG. 1 and also in connection with FIG. 2.

In an embodiment that is not shown here, it is also possible for an individual accumulator, additionally or alternatively, to be integrated as a separate buffer volume in the high-pressure component 14 outside the injector 8, for example, in a supply line 13 from the rail 6 to the injector 8.

The common rail system 15 with individual accumulators 10 differs from a common rail system without individual accumulators in that the fuel to be injected is taken from the individual accumulator 10. During the injection pause, precisely so much fuel flows hack into the individual accumulator 10 from the rail 6 that at the start of injection the individual accumulator 10 is once again completely filled, so that the pressure in the individual accumulator 10 is then as high as the pressure pCR in the rail 6.

The hydraulic resistance of the individual accumulator 10 and that of the supply line 13 from the rail 6 to the injector 8 are adjusted to each other in such a way in the present case that the supply line 13 from the rail to the individual accumulator 10 in the injector has comparatively high hydraulic resistance 16. The hydraulic resistance 16 of the high-pressure component 14 is formed in such a way relative to a course of the diameter of the supply line 13 of the high-pressure component 14 along an axial direction of conveyance of the fuel upstream of the individual accumulator 10 that the course of the diameter forms a throat. The hydraulic resistance 16 of the high-pressure component 14 thus practically constitutes a throttle immediately upstream of the individual accumulator 10. In other words, the high-pressure fuel guide has a hydraulic resistance 16 upstream of the individual accumulator 10 which is greater than a hydraulic resistance immediately after the outlet of the rail 6. By contrast, in a previously known common rail system without individual accumulators, which is not illustrated here, the hydraulic resistance between a rail and injector is usually kept as low as possible, so that injection which is as immediate and unhindered as possible can be achieved. In the present case, however, as a result of the hydraulic resistance 16 of the high-pressure component 14 being located immediately upstream of the individual accumulator 10, feedback of hydraulic disturbance variables from the rail 6 to the individual accumulator 10 is suppressed.

In the present case in FIG. 1, the individual accumulator 10 extends into a distal end 18 of the injector 8 opposite the injector tip 17. A high-pressure connection 19 of the high-pressure fuel guide opens directly into the individual accumulator 10. In the present case of FIG. 1, a volume of the individual accumulator 10 together with a volume of the high-pressure connection 19 of the high-pressure guide forms an approximately L-shaped cross section at the individual accumulator 10.

FIG. 2 shows the high-pressure component 14 in a modified form. The same reference numbers are used. The modified high-pressure component 14 likewise has an injector 8 with an integrated individual accumulator 10 and a symbolically illustrated hydraulic resistance 16 in the supply line 13. The hydraulic resistance 16 is located immediately upstream of the individual accumulator 10. The high-pressure channel 20 of the high-pressure connection 19 opens directly into the individual accumulator 10. In the modified embodiment of FIG. 2, the individual accumulator 10 is arranged in a body 21 of the injector 8 that is located some distance from the injector tip 17, such that the body 21 is spaced some distance from both the injector tip 17 and the opposite distal end 18 of the injector 8. In the modified embodiment of the high-pressure component 14 of FIG. 2, a volume of the individual accumulator 10 together with a volume (namely, the high-pressure channel 20) of the high-pressure connection 19 of the high-pressure guide forms an approximately T-shaped cross section at the individual accumulator 10.

These and other modifications for integrating the individual accumulator 10 in the injector 8 can be undertaken without departing from the idea of the invention. In any ease, an individual accumulator 10 is characterized by a greater volume compared to a high-pressure channel of the high-pressure guide—whether it be a high-pressure channel 20 in the injector or a high-pressure line 13. A diameter of the individual accumulator 10 determined transversely to an axial direction of conveyance of the fuel is, in particular, greater than a transverse diameter of the high-pressure component 14 determined transversely to an axial direction of conveyance of the fuel. In the present ease, the diameter of the high-pressure channel 20 is much smaller than the diameter of the individual accumulator 10.

It has been found that the greater volume or the greater diameter of an individual accumulator 10 in accordance with the idea of the invention can be advantageously utilized to use the measuring signal of a strain sensor 12 mounted directly on the outside 11 of the individual accumulator 10, which in the present case takes the form of a strain gage. Specifically, it has been found that due to the greater diameter of the individual accumulator 10 in relation to the wall of the body 21 of the injector 8, a measuring signal on the individual accumulator 10 is much greater compared to a hypothetical measuring signal on a high-pressure guide, whose diameter is smaller than the diameter of the individual accumulator.

The idea of the invention allows improved automatic control of the injection or better determination of the start of injection, which is activated by the lifting of the injector needle 22 in the injector tip 17, which in turn is followed by the injection of fuel through openings 23 in the end of the injector tip.

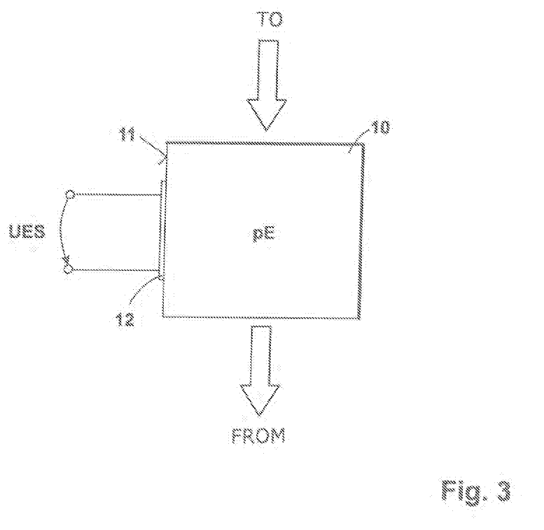

The automatic control on the basis of an electronic control unit (ECU) 9 is explained, by way of example, on the basis of FIG. 1 and an individual accumulator 10 with a strain gage 12 shown symbolically in FIG. 3. The electronic control unit 9 contains the usual components of a microcomputer system, for example, a microprocessor, interface adapters, buffers and memory components (EEPROM, RAM). Operating characteristics that are relevant to the operation of the internal combustion engine 1 are applied in the memory components in the form of input-output maps/characteristic curves. The electronic control unit 9 uses these to compute the output variables from the input variables. FIG. 1 shows the input variables as examples:
the pressure in the rail 6 (pCR), which is measured by another pressure sensor 7 in the rail 6.
an engine speed signal (nMOT) of the internal combustion engine 1,
a number of pressure signals (pE) of the number of individual accumulators 10, of which one is symbolically illustrated here, and, for example, a voltage (UES) emitted by the strain gage, as shown in FIG. 3.

Additional input variables, which depend on the given application, are represented by IN, which is symbolic for a number of operating states. These input variables include, for example, the charge air pressure of a turbocharger and the temperatures of the coolant/lubricant and fuel.

As output signals of the electronic control unit 9. FIG. 1 shows a pulse-width-modulated signal (PWM) for controlling the suction throttle 4, a signal (INJ) for controlling the number of injectors 8, such that the signal (INJ) comprises especially individual signals for determining the start of injection and/or the end of injection. Additional output signals are combined in the output variable (OUT). This output variable (OUT) is representative of other control signals for controlling the internal combustion engine 1, for example, an EGR valve.

FIG. 3 shows in a highly simplified way the individual accumulator 10, as it is shown symbolically in FIG. 1 or practically realized in FIG. 2. In the high-pressure component 14, which is not shown in FIG. 3, the fuel is supplied (TO) through a high-pressure fuel guide, while the fuel is delivered (FROM) to the working chamber of the internal combustion engine 1 through the tip 17 of the injector. A variable pressure level pE prevails inside the individual accumulator 10. This pressure level pE varies from 0 bars when the engine is shit off to a maximum value of, for example, 1,800 bars at full load. It is also possible to realize a higher maximum value of certainly as high as 3,000 bars and in the present case certainly a maximum value of 2,200-2,500 bars. As was explained earlier in connection with FIG. 1 and FIG. 2, a strain sensor 12 in the form of a strain gage is mounted on the outside 11 of the individual accumulator 10. This strain sensor 12 converts the mechanical volume change of the individual accumulator 10 to an electrical signal UES, which relays the pressure level pE of the individual accumulator to the electronic control unit 9. The electrical signal UES is analyzed in the electronic control unit 9 by a bridge circuit; for example, a Wheatstone bridge.

### REFERENCE NUMBERS AND ABBREVIATIONS

1 internal combustion engine
2 fuel tank
3 low-pressure pump
4 suction throttle
5 high-pressure pump
6 high-pressure source
7 rail pressure sensor
8 injector
9 electronic device, electronic control unit
10 individual accumulator
11 outside
12 strain sensor
13 supply line, high-pressure line
14 high-pressure component
15 common rail fuel injection system
16 resistance
17 injector tip
18 distal end
19 high-pressure connection
20 high-pressure channel
21 body
22 injector needle
23 opening at the end
nMOT engine speed
pE individual accumulator pressure
pCR rail pressure
PWM pulse-width-modulated signal
INJ injector control signal (start/end of injection)
IN additional input signals
OUT additional output signal's

1. An individual accumulator for a high-pressure component of a high-pressure fuel guide of a common rail fuel injection system equipped with a source of high pressure and a fuel injector, which has a fluid connection with the source of high pressure via the high-pressure fuel guide, for injecting fuel into a working chamber of an internal combustion engine, wherein the individual accumulator comprises a pressure sensor designed as a strain sensor.

2. The individual accumulator in accordance with claim 1, wherein the strain sensor is a strain gage.

3. The individual accumulator in accordance with claim 1, comprising a housing having an outer wall, the strain sensor being mounted on an outer side of the wall of the housing.

4. A high-pressure component of a high-pressure fuel guide of a common rail fuel injection system having a source of high pressure, a fuel injector and an individual accumulator having a pressure sensor designed as a strain sensor, wherein the high-pressure component is configured for connection to or integration in a high-pressure line outside the injector.

5. A high-pressure component of a high-pressure fuel guide of a common rail fuel injection system with an individual accumulator according to claim 1, wherein the high-pressure component is an injector.

6. The high-pressure component in accordance with claim 5, wherein the individual accumulator is connected to or integrated in a high-pressure channel within the injector.

7. The high-pressure component in accordance with claim 5, wherein the individual accumulator is arranged at a distal end of the injector opposite a tip of the injector.

8. The high-pressure component in accordance with claim 5, wherein the individual accumulator is arranged in a body of the injector that is located a distance from a tip of the injector, which body is spaced a distance from a distal end of the injector opposite the injector tip.

9. The high-pressure component in accordance with claim 5, and further comprising a hydraulic resistance arranged immediately upstream of the individual accumulator for integration in the high-pressure fuel guide.

10. The high-pressure component in accordance with claim 4, wherein the strain sensor is a strain gage.

11. The high-pressure component in accordance with claim 4, wherein the strain sensor is mounted on an outer side of a wall of the individual accumulator.

12. The high-pressure component in accordance with claim 4, wherein the high-pressure fuel guide has a high-pressure connection that opens directly into the individual accumulator.

13. The high-pressure component in accordance with claim 12, wherein a volume of the individual accumulator together with a volume of the high-pressure connection of the high-pressure guide forms an approximately T-shaped or approximately L-shaped cross section at the individual accumulator.

14. The high-pressure component in accordance with claim 4, wherein a diameter of the individual accumulator determined transversely to an axial direction of conveyance of the fuel is greater than a transverse diameter of the high-pressure component upstream of the individual accumulator determined transversely to an axial direction of conveyance of the fuel.

15. The high-pressure component in accordance with claim 4, wherein the high-pressure component has a diameter with a course along an axial direction of conveyance of the fuel that has a throat upstream of the individual accumulator.

16. A common rail fuel injection system comprising:
a high-pressure source;
a fuel injector; and
a high-pressure guide for placing the fuel injector in fluid connection with the high pressure source, for injecting fuel into a working chamber of an internal combustion engine, wherein the high-pressure guide has a high-pressure component and/or individual accumulator with a pressure sensor, the pressure sensor being designed as a strain sensor.

17. The common rail fuel injection system in accordance with claim 16, wherein the strain sensor is a strain gage.

18. The common rail fuel injection system in accordance with claim 16, wherein the high-pressure guide has a hydraulic resistance upstream of the individual accumulator that is greater than a hydraulic resistance of the high-pressure guide after an outlet of the high-pressure source.

19. The common rail fuel injection system in accordance with claim 16, wherein in the high-pressure guide, only the individual accumulator is provided with a pressure sensor.

20. The common rail fuel injection system in accordance with claim 19, wherein the pressure sensor is a strain gage.

21. The common rail fuel injection system in accordance with claim 16, wherein the high-pressure source also has a strain sensor.

22. An internal combustion engine, comprising:
a common rail fuel injection system, having a high-pressure source, a fuel injector, and a high-pressure guide for placing the fuel injector in fluid connection with the high pressure source, for injecting fuel into a working chamber of the internal combustion engine, wherein the high-pressure guide has a high-pressure component and/or individual accumulator with a pressure sensor the pressure sensor being designed as a strain sensor; and
an electronic control unit for open-loop or closed-loop control of the internal combustion engine, the electronic control unit being operative to process a measured quantity of a strain sensor for the pressure of the individual accumulator.

23. The internal combustion engine in accordance with claim 22, wherein the electronic control unit has a signal input connected with a signal output of the strain sensor.

24. An electronic control unit for the open-loop and/or closed-loop control of an internal combustion engine having a common rail fuel injection system including a high-pressure source, a fuel injector, and a high-pressure guide for placing the fuel injector in fluid connection with the high pressure source, for injecting fuel into a working chamber of the internal combustion engine, wherein the high-pressure guide has a high-pressure component and/or individual accumulator with a pressure sensor the pressure sensor being designed as a strain sensor, wherein the electronic control unit is operative to process a measured quantity of a strain sensor for the pressure of the individual accumulator.

25. The electronic control unit in accordance with claim 24, wherein the electronic control unit has a signal input connectable with a signal output of the strain sensor.

26. A method for open-loop and/or closed-loop control of an internal combustion engine with a common rail fuel injection system having a high-pressure source, a fuel injector, and a high-pressure guide for placing the fuel injector in fluid connection with the high pressure source, for injecting fuel into a working chamber of the internal combustion engine, wherein the high-pressure guide has a high-pressure component and/or individual accumulator with a pressure sensor, the pressure sensor being designed as a strain sensor, the method comprising the steps of:
detecting and storing a pressure of the individual accumulator during a measurement interval; and
interpreting a significant change in the pressure as a start of injection or an end of injection for the control system, wherein the pressure of the individual accumulator is measured by a pressure sensor formed as a strain sensor on the individual accumulator the steps being carried out by an electronic control unit.

27. The method in accordance with claim 26 including supplying a measured quantity for the pressure of the individual accumulator as a signal at a signal output at the strain sensor, and
determining a first measured pressure value before the internal combustion engine is started;
determining a second measured pressure value in a static state of the internal combustion engine; and
relating a third measured pressure value to the first and/or the second measured pressure value.

28. The method in accordance with claim 26, further including measuring and relating the pressure of the high-pressure source to the pressure of the individual accumulator.

29. The method in accordance with claim 27, including making the pressure of the individual accumulator available to the control system instead of the pressure of the high-pressure source.

30. The method in accordance with claim 26, including measuring the pressure of the individual accumulator by the strain sensor on the individual accumulator for the open-loop and/or closed-loop control of the internal combustion engine with a common rail fuel injection system during the course of a main injection and/or preinjection and/or post-injection.
